(19) United States
(12) Patent Application Publication
(10) Pub. No.: US 2015/0375675 A1
(43) Pub. Date: Dec. 31, 2015

(54) ILLUMINATED VEHICLE INTERIOR COMPONENT

(71) Applicant: JOHNSON CONTROLS TECHNOLOGY COMPANY, Holland,, MI (US)

(72) Inventors: Ronald A. Bozio, Holland, MI (US); Scott A. Hansen, Holland, MI (US); Jonathan M. Frens, Hudsonville, MI (US); David J. McCarthy, Holland, MI (US); Mark J. Tuttle, Hudsonville, MI (US); Jason M. Hipshier, Hudsonville, MI (US); Greg Hodgins, Grandville, MI (US)

(21) Appl. No.: 14/764,878

(22) PCT Filed: Jan. 30, 2014
(86) PCT No.: PCT/US2014/013879

§ 371 Date: Jul. 30, 2015

Related U.S. Application Data
(60) Provisional application No. 61/759,178, filed on Jan. 31, 2013.

(51) Int. Cl. B60Q 3/02; B60R 7/04; B60Q 3/00

(52) U.S. Cl. CPC B60Q 3/022; B60Q 3/004; B60R 7/04; B60Q 3/001

(57) ABSTRACT

A vehicle interior assembly includes an interior trim component at least partially enclosing a storage volume and having a recessed compartment. The interior trim component is configured to transition between a first position, a second position, and a third position relative to a support structure. The vehicle interior assembly also includes a first light transmissive element coupled to the interior trim component and configured to illuminate an exterior surface of the interior trim component. In addition, the vehicle interior assembly includes a second light transmissive element coupled to the interior trim component and configured to illuminate a first interior of the recessed compartment. The vehicle interior assembly further includes a light source coupled to the support structure. The light source is positioned to optically communicate with the first light transmissive element while the interior trim component is located in the first position, to optically communicate with the second light transmissive element while the interior trim component is located in the second position, and to otherwise illuminate a second interior of the storage volume.

### CROSS REFERENCE TO RELATED APPLICATIONS

This application is a national stage of PCT Application No. PCT/US2014/013879, entitled “ILLUMINATED VEHICLE INTERIOR COMPONENT”, filed on Jan. 30, 2014, which claims priority from and the benefit of U.S. Provisional Application Ser. No. 61/759,178, entitled “ILLUMINATED VEHICLE INTERIOR COMPONENT”, filed Jan. 31, 2013. Each of the foregoing applications is hereby incorporated by reference in its entirety.

### BACKGROUND

The invention relates generally to an illuminated vehicle interior component.

Storage compartments may be positioned throughout an interior of a vehicle to store cargo and other small items. For example, an overhead console may include a storage compartment suitable for storing sunglasses, driving glasses, or other items. Other storage compartments may be located within a center console, an armrest, seats, door panels, or other areas of the vehicle interior. Certain storage compartments include a door configured to secure the contents of the compartment and/or to hide the contents from view.

While certain storage compartments include lighting to illuminate an interior of the storage compartment, such lighting is typically not visible when the storage compartment door is in a closed position. Consequently, a driver or passenger within the vehicle may experience difficulty locating the storage compartment in low light conditions (e.g., while driving at night). Unfortunately, employing supplementary lighting to illuminate the storage compartment door increases vehicle cost due to the extra components associated with providing an additional light source and electrical connections.

### SUMMARY

The present invention relates to a vehicle interior assembly including a base and a light source. The vehicle interior assembly also includes a component movable relative to the base and configured so that movement of the component relative to the base includes a first state with the component in a first position, a second state with the component in a second position, and a third state with the component in a third position. When the component is in the first state a first light transmissive element is illuminated by the light source, and when the component is in the second state a second light transmissive element is illuminated by the light source.

The present invention also relates to a vehicle interior assembly including a base and a light source configured to provide light. The vehicle interior assembly also includes a component movable relative to the base and configured so that movement of the component relative to the base includes a first state with the component in a first position and a second state with the component in a second position. The vehicle interior assembly further includes an interface including a first section and a second section movable relative to the first section within a guide. The first section and the second section are engaged when the component is in the first position, and the light from the light source is transmitted through the second section of the interface when the component is in the first position. In addition, the first section and the second section are separated when the component is in the second position, and the light from the light source is transmitted through the second section of the interface when the component is in the second position. Furthermore, the light from the light source is transmittable from the first section to the second section, and the guide is configured to facilitate alignment of the first section with the second section and separation of the first section and the second section.

The present invention further relates to a vehicle interior assembly including a base, a handle, and a light source configured to provide light to illuminate a first light transmissive element and a second light transmissive element. The vehicle interior assembly also includes a component movable relative to the base and configured so that movement of the component relative to the base includes a closed state with the component in a closed position, a first open state to provide access to a first storage compartment, and a second open state to provide access to a second storage compartment. When the component is in the first open state the first light transmissive element is illuminated to provide lighting for the first storage compartment, when the component is in the second open state the light source provides lighting for the second storage compartment, and when the component is in the closed state the second light transmissive element is illuminated to provide lighting for the handle.

### DRAWINGS

FIG. 1A is a perspective view of an exemplary vehicle that may include an interior assembly having an illuminated trim component.

FIG. 1B is a cutaway perspective view of the vehicle of FIG. 1A.

FIG. 2A is a perspective view of an embodiment of an interior of a vehicle.

FIG. 2B is a perspective view of an embodiment of a floor console having an illuminated trim component.

FIG. 3A is a schematic view of an embodiment of a vehicle interior assembly having a movable storage compartment in a closed position.

FIG. 3B is a detailed schematic view of a portion of the vehicle interior assembly of FIG. 3A, taken within line 3B-3B.

FIG. 4A is a schematic view of the vehicle interior assembly of FIG. 3A, in which a handle of the movable storage compartment is in an actuated position.

FIG. 4B is a detailed schematic view of a potion of the vehicle interior assembly of FIG. 4A, taken within line 4B-4B.

FIG. 5 is a schematic view of the vehicle interior assembly of FIG. 3A, in which the movable storage compartment is in an intermediate position.

FIG. 6 is a schematic view of the vehicle interior assembly of FIG. 3A, in which the movable storage compartment is in an open position.

### DETAILED DESCRIPTION

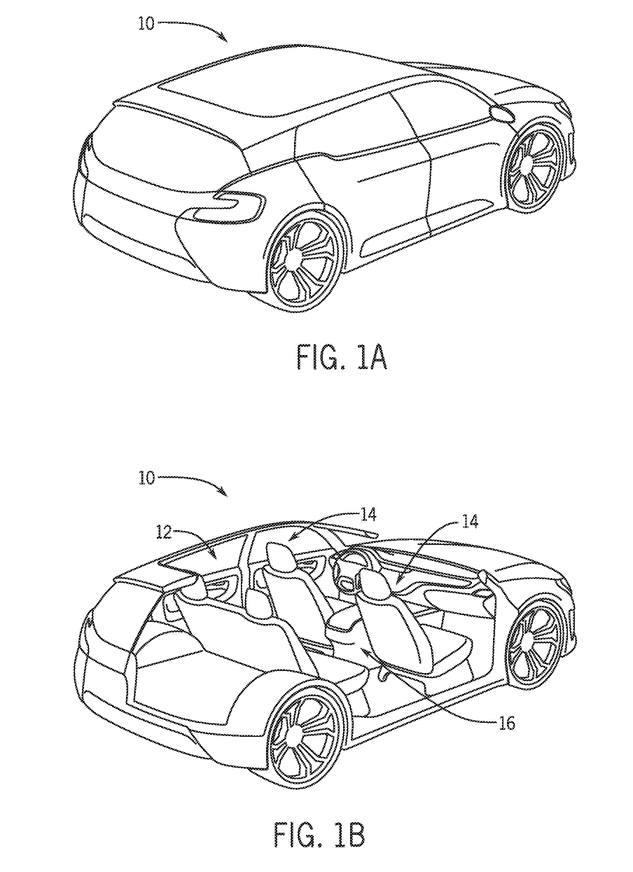

FIG. 1A is a perspective view of an exemplary vehicle 10, and FIG. 1B is a cutaway perspective view of the vehicle 10. The vehicle 10 may include an interior assembly having an illuminated trim component. As illustrated, the vehicle 10 includes an interior 12 having seats 14 and a floor console 16. As discussed in detail below, the floor console 16 and/or other areas within the interior 12 may be illuminated to enhance visibility of a storage compartment and/or an interior trim component. For example, in certain embodiments, the vehicle 10 includes an interior assembly having an interior trim component at least partially enclosing a storage volume. The interior trim component includes a recessed compartment, such as a beverage container receptacle, and the interior trim component is configured to transition between a first position, a second position, and a third position relative to a support structure. The vehicle interior assembly also includes a first light transmissive element coupled to the interior trim component and configured to illuminate an exterior surface of the interior trim component to enhance visibility in low light conditions. In addition, the vehicle interior assembly includes a second light transmissive element coupled to the interior trim component and configured to illuminate an interior of the recessed compartment. The vehicle interior assembly also includes a light source coupled to the support structure. The light source is positioned to optically communicate with the first light transmissive element while the interior trim component is located in the first position, to optically communicate with the second light transmissive element while the interior trim component is located in the second position, and to otherwise illuminate the interior of the storage volume. Such a configuration may enhance the visibility of the interior trim component and illuminate the interior of multiple storage compartments with a single light source, thereby reducing cost compared to configurations that employ individual light sources to illuminate each component/compartment.

The vehicle interior assembly may also include a light transmission assembly configured to transfer light from a fixed light source to a moving component. For example, in certain embodiments, the vehicle interior assembly includes an interior trim component having a body and a movable element configured to move relative to the body. The vehicle interior assembly also includes a light transmission assembly having a first light transmissive element coupled to the body and a second light transmissive element coupled to the movable element. The second light transmissive element is movable relative to the first light transmissive element, the second light transmissive element is optically coupled to the first light transmissive element throughout a range of motion of the second light transmissive element, and the second light transmissive element is optically coupled to an exterior surface of the movable element. In addition, the vehicle interior assembly includes a light source configured to emit light through the first and second light transmissive elements to illuminate the exterior surface of the movable element while the light source is in optical communication with the first light transmissive element. Such a configuration may facilitate illumination of a moving component with a fixed light source, thereby reducing costs compared to configurations that employ movable light sources having complex power supply wiring.

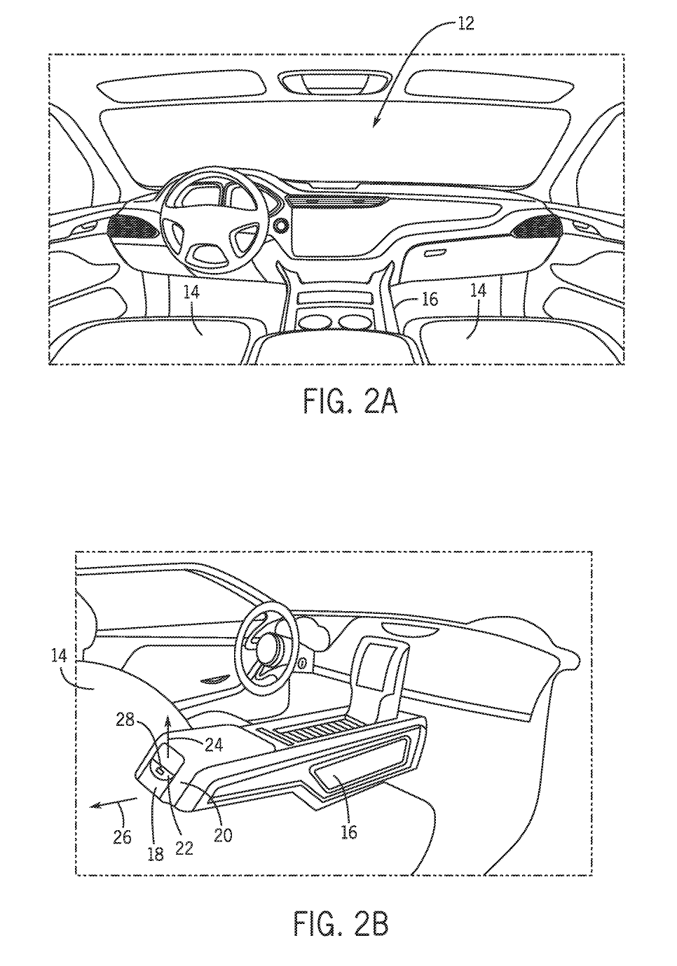

FIG. 2A is a perspective view of an embodiment of an interior 12 of the vehicle, and FIG. 2B is a perspective view of an embodiment of a floor console 16 having an illuminated trim component. As illustrated, the floor console 16 includes a movable storage compartment 18 configured to move relative to a support structure 20. For example, in certain embodiments, the movable storage compartment 18 is configured to transition between the illustrated closed position that substantially encloses an interior of a storage volume within the movable storage compartment 18 and an open position that facilitates access to the interior of the storage volume. In addition, the movable storage compartment 18 includes a handle 22 configured to actuate a locking mechanism. Movement of the storage compartment 18 relative to the support structure 20 is blocked by the locking mechanism until an occupant raises the handle 22 in the direction 24, thereby releasing the locking mechanism. With the locking mechanism released, the occupant may move the storage compartment 18 in the direction 26 (e.g., in a rearward direction relative to a direction of travel of the vehicle 10) to facilitate access to the interior of the storage volume.

In certain embodiments, the movable storage compartment 18 includes a recessed beverage container receptacle. In such embodiments, the movable storage compartment 18 is configured to transition between a closed position that substantially encloses the interior of the storage volume and an interior of the recessed beverage container receptacle, and an intermediate position that facilitates access to the interior of the recessed beverage container receptacle while substantially enclosing the interior of the storage volume. The movable storage compartment 18 may also transition to the open position that facilitates access to the interior of the storage volume and the interior of the recessed beverage container receptacle.

The floor console 16 also includes a first light transmissive assembly coupled to the movable storage compartment 18 and configured to illuminate an exterior surface of the movable storage compartment (e.g., via an illuminated element 28). In addition, the floor console 16 includes a second light transmissive element coupled to the movable storage compartment and configured to illuminate the interior of the recessed beverage container receptacle. The floor console 16 further includes a light source located in a fixed position relative to the movable storage compartment 18 (e.g., coupled to the support structure 20). The light source is positioned to emit light through the first light transmissive element while the movable storage compartment 18 is located in the closed position, to emit light through the second light transmissive element while the movable storage compartment 18 is located in the intermediate position, and to otherwise illuminate the interior of the storage volume. Accordingly, while the movable storage compartment 18 is in the closed position, the light source illuminates the exterior surface of the storage compartment, thereby facilitating identification of the handle 22/storage compartment 18 in low light conditions (e.g., while driving at night). In addition, while the movable storage compartment 18 is in the intermediate position, the light source illuminates the recessed beverage container receptacle, thereby facilitating identification of the beverage container receptacle in low light conditions. Furthermore, while the movable storage compartment 18 is in the open position, the light source illuminates the interior of the storage volume, thereby facilitating access to the storage volume in low light conditions.

Because the exterior surface of the movable storage compartment, the interior of the recessed beverage container receptacle, and the interior of the storage volume may be illuminated with a single light source, the cost and complexity of the floor console 16 may be substantially reduced, as compared to consoles employing multiple light sources having separate power supply wiring and/or circuit boards. While the movable storage compartment 18 is described below with reference to a floor console 16, it should be appreciated that the movable storage compartment 18 may be employed within other vehicle interior assemblies (e.g., an overhead console, a center console, a door panel, etc.). In addition, while a movable storage compartment is described below, it should be appreciated that the lighting system (e.g., the light source and the light transmissive elements) may be utilized within other interior trim components having enclosed storage volumes and recessed compartments (e.g., recessed beverage container receptacles).

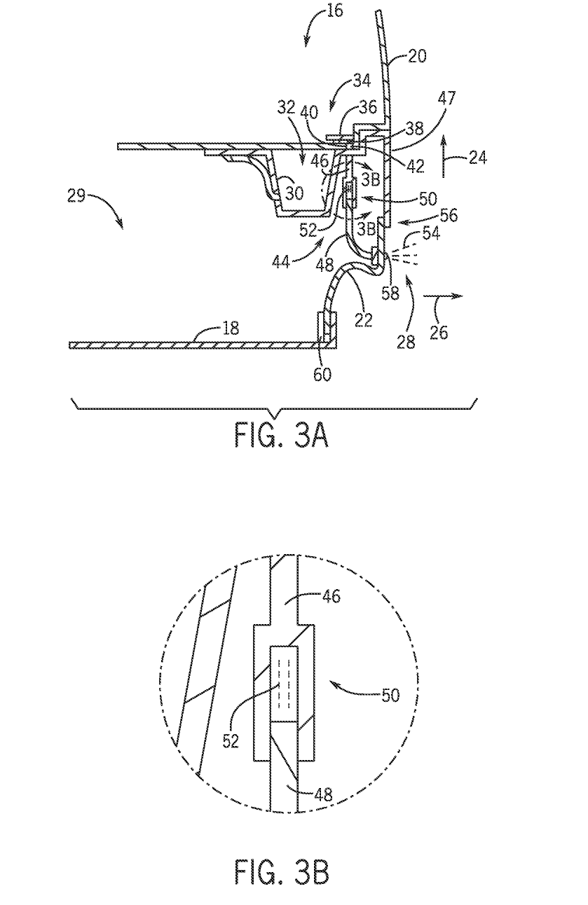

FIG. 3A is a schematic view of an embodiment of a vehicle interior assembly having a movable storage compartment 18 in a closed position. As illustrated, the movable storage compartment 18 includes a storage volume 29 configured to retain a variety of objects within the storage compartment 18. The storage compartment 18 also includes a recessed beverage receptacle 30 having an interior 32 configured to receive and storage (e.g., hold in place during operation of the vehicle) a beverage container. As previously discussed, the storage compartment 18 may move in the direction 26 from the illustrated closed position, in which an interior of the storage volume 29 and the interior 32 of the recessed beverage container receptacle 30 are substantially enclosed, to an intermediate position that facilitates access to the interior 32 of the recessed beverage container 30. The storage compartment 18 may move farther in the direction 26 to transition the storage compartment 18 from the intermediate position to an open position that facilitates access to the interior 32 of the recessed beverage container receptacle 30 and the interior of the storage volume 29.

In the illustrated embodiment, the floor console 16 includes a lighting assembly 34 having a circuit board 36 and a light source 38 coupled to the circuit board 36. The light source 38 may be any suitable type of light source, such as one or more incandescent bulbs, fluorescent lights, and/or light emitting diodes (LEDs). By way of example, the light source 38 may include multiple LEDs surface-mounted to the circuit board 36. As discussed in detail below, the light source 38 is configured to emit light toward a light transmissive element and/or toward the interior of the storage volume 29. As will be appreciated, the intensity, color, and/or frequency of the light may be selected based on a desired lighting effect. In addition, the intensity, color, and/or frequency of the light may by adjusted based on the position of the movable storage compartment 18 and/or the handle 22.

In the illustrated embodiment, the lighting assembly 34 is coupled to the support structure 20, and the light source 38 is configured to emit light 40 through a window 42 (e.g., opening or transparent element) in the support structure 20. With the movable storage compartment 18 in the illustrated closed position, a light transmission assembly 44 directs the light to the illuminated element 28, thereby illuminating an exterior surface of the storage compartment 18/handle 22. In the illustrated embodiment, the light transmission assembly 44 includes a first light transmissive element 46 coupled to a body 47 of the movable storage compartment 18, and a second light transmissive element 48 coupled to the handle 22. The second light transmissive element 48 is movable relative to the first light transmissive element 46, and optically coupled to the first light transmissive element 46 throughout a range of motion of the second light transmissive element 48. The second light transmissive element 48 is also optically coupled to an exterior surface of the handle 22. For example, as shown in FIG. 3B, the first and second light transmissive elements may be slidably coupled to one another via an interface 50 that facilitates movement of the second light transmissive element 48 relative to the first light transmissive element 46. The interface 50 also enables light 52 passing through the first light transmissive element 46 to be received by the second light transmissive element 48. As will be appreciated, any suitable interface 50 configured to movably and optically couple the light transmissive elements to one another may be employed. In the illustrated embodiment, the first and second light transmissive elements 46 and 48 include substantially rigid light guides. However, it should be appreciated that the light transmissive elements may include other light transmissive components in further embodiments.

The light source 38 emits light through the first and second light transmissive elements to project light 54 from the exterior surface 56 of the handle 22. In certain embodiments, the light transmission assembly 44 includes a lens 58 coupled to the exterior surface 56 of the handle 22 and optically coupled to the second light transmissive element 48. The lens 58 may be configured to direct the light 54 over a wide area, thereby enhancing the visibility of the storage compartment 18 in low light conditions. As will be appreciated, the lens may be tinted to establish a desired lighting effect.

In the illustrated embodiment, the floor console 16 includes a locking mechanism 60 configured to selectively block movement of the storage compartment 18 relative to the support structure 20. The locking mechanisms 60 is coupled to the handle 22, which is configured to actuate the locking mechanism 60. For example, moving the handle 22 in the direction 24 disengages the locking mechanism 60, thereby facilitating movement of the storage compartment 18 in the direction 26. As the handle 22 moves in the direction 24, the second light transmissive element 48 moves relative to the first light transmissive element 46. However, because the second light transmissive element 48 is optically coupled to the first light transmissive element 46 through the range of motion of the second light transmissive element, light from the light source 38 may illuminate the exterior surface 56 of the handle 22 as the handle 22 moves in the direction 24. As a result, the handle 22 may be illuminated by a single fixed light source.

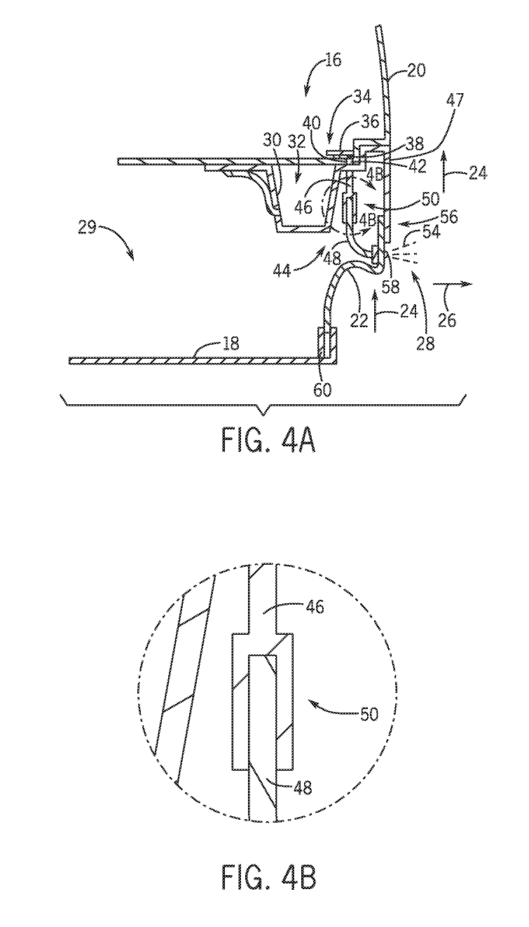

FIG. 4A is a schematic view of the vehicle interior assembly of FIG. 3A, in which the handle 22 of the movable storage compartment 18 is in an actuated position. As previously discussed, movement of the handle 22 in the direction 24 disengages the locking mechanism 60, thereby facilitating movement of the storage compartment 18 in the direction 26. In addition, movement of the handle 22 drives the second light transmissive element 48 in the direction 24 toward the first light transmissive element 46, as shown in FIG. 4B. Because the light transmissive elements are optically coupled to one another, the exterior surface 56 of the handle 22 is illuminated throughout a range of motion of the handle 22. Accordingly, the handle 22 may be illuminated by a single fixed light source 38, thereby reducing costs compared to configurations that employ movable light sources having complex power supply wiring.

While the illustrated light source 38 is coupled to the support structure 20, it should be appreciated that the light source 38 may be coupled to the movable storage compartment 18 in alternative embodiments. In addition, while the light transmission assembly 44 is employed to illuminate an exterior surface 56 of a handle 22, it should be appreciated that a light transmission assembly having multiple movable light transmissive elements may be employed to illuminate other movable components within the vehicle interior. Furthermore, it should be appreciated that the light transmission assembly 44 may include additional light transmissive elements (e.g., 3, 4, 5, or more) in alternative embodiments. In such embodiments, the light transmissive elements are movably and optically coupled to one another to facilitate light passage through the light transmission assembly and to accommodate movement of a movable element relative to a fixed light source.

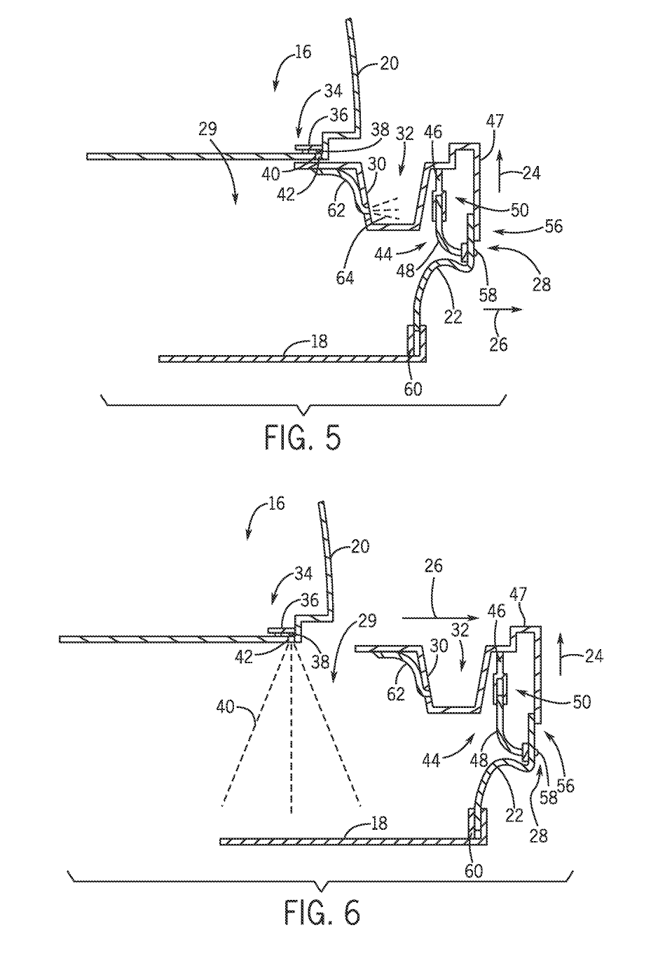

FIG. 5 is a schematic view of the vehicle interior assembly of FIG. 3A, in which the movable storage compartment 18 is in an intermediate position. As previously discussed, transitioning the movable storage compartment 18 to the intermediate position facilitates access to the recessed beverage container receptacle 32, while blocking access to the storage volume 29 of the storage compartment 18. In the illustrated embodiment, the floor console 16 includes a third light transmissive element 62 coupled to the movable storage compartment 18 and configured to illuminate the interior 32 of the recessed beverage container receptacle 30. With the movable storage compartment 18 in the illustrated intermediate position, an end of the third light transmissive element 62 is substantially aligned with the light source 38. Accordingly, while the movable storage compartment 18 is in the intermediate position, light from the light source 38 passes through the third light transmissive element 62, thereby illuminating the interior 32 of the recessed beverage container receptacle 30, as indicated by the emitted light 64.

While the illustrated movable storage compartment 18 includes a single recessed beverage container receptacle 30, it should be appreciated that the storage compartment may include more or fewer beverage container receptacles in alternative embodiments. For example, in certain embodiments, the storage compartment may include 1, 2, 3, 4, 5, 6, or more illuminated beverage container receptacles. In addition, it should be appreciated that other recessed compartments within a movable interior trim component may be illuminated by alignment of a light transmissive element with a fixed light source.

FIG. 6 is a schematic view of the vehicle interior assembly of FIG. 3A, in which the movable storage compartment is in an open position. As previously discussed, transitioning the movable storage compartment 18 to the open position facilitates access to the recessed beverage container receptacle 32 and the storage volume 29 of the storage compartment 18. While the storage compartment 18 is in the illustrated open position, the light source 38 illuminates the interior of the storage volume 29 via the emitted light 40. Accordingly, the visibility of items within the storage volume 29 is enhanced. Because the illustrated vehicle interior assembly is configured to enhance the visibility of the movable storage compartment and to illuminate the interior of multiple storage compartments with a single light source, the cost of the vehicle interior assembly may be reduced, as compared to configurations that employ individual light sources to illuminate each component/compartment.

In certain embodiments, a vehicle interior assembly includes an interior trim component at least partially enclosing a storage volume and having a recessed compartment. The interior trim component is configured to transition between a first position, a second position, and a third position relative to a support structure. The vehicle interior assembly also includes a first light transmissive element coupled to the interior trim component and configured to illuminate an exterior surface of the interior trim component. In addition, the vehicle interior assembly includes a second light transmissive element coupled to the interior trim component and configured to illuminate a first interior of the recessed compartment. The vehicle interior assembly further includes a light source coupled to the support structure. The light source is positioned to optically communicate with the first light transmissive element while the interior trim component is located in the first position, to optically communicate with the second light transmissive element while the interior trim component is located in the second position, and to otherwise illuminate a second interior of the storage volume.

In further embodiments, a vehicle interior assembly includes a movable storage compartment having a storage volume and a recessed beverage container receptacle. The movable storage compartment is configured to transition between a closed position that substantially encloses a first interior of the storage volume and a second interior of the recessed beverage container receptacle, an intermediate position that substantially encloses the first interior of the storage volume and facilitates access to the second interior of the recessed beverage container receptacle, and an open position that facilitates access to the first interior of the storage volume and the second interior of the recessed beverage container receptacle. The vehicle interior assembly also includes a first light transmissive element coupled to the movable storage compartment and configured to illuminate an exterior surface of the movable storage compartment. In addition, the vehicle interior assembly includes a second light transmissive element coupled to the movable storage compartment and configured to illuminate the second interior of the recessed beverage container receptacle. The vehicle interior assembly further includes a light source located in a fixed position relative to the movable storage compartment. The light source is positioned to emit light through the first light transmissive element while the movable storage compartment is located in the closed position, to emit light through the second light transmissive element while the movable storage compartment is located in the intermediate position, and to otherwise illuminate the first interior of the storage volume.

In further embodiments, a vehicle interior assembly includes an interior trim component having a body and a movable element configured to move relative to the body. The vehicle interior assembly also includes a light transmission assembly having a first light transmissive element coupled to the body and a second light transmissive element coupled to the movable element. The second light transmissive element is movable relative to the first light transmissive element, the second light transmissive element is optically coupled to the first light transmissive element throughout a range of motion of the second light transmissive element, and the second light transmissive element is optically coupled to an exterior surface of the movable element. In addition, the vehicle interior assembly includes a light source configured to emit light through the first and second light transmissive elements to illuminate the exterior surface of the movable element while the light source is in optical communication with the first light transmissive element.

While only certain features and embodiments of the invention have been illustrated and described, many modifications and changes may occur to those skilled in the art (e.g., variations in sizes, dimensions, structures, shapes and proportions of the various elements, values of parameters (e.g., temperatures, pressures, etc.), mounting arrangements, use of materials, colors, orientations, etc.) without materially departing from the novel teachings and advantages of the subject matter recited in the claims. The order or sequence of any process or method steps may be varied or resequenced according to alternative embodiments. It is, therefore, to be understood that the appended claims are intended to cover all such modifications and changes as fall within the true spirit of the invention. Furthermore, in an effort to provide a concise description of the exemplary embodiments, all features of an actual implementation may not have been described (i.e., those unrelated to the presently contemplated best mode of carrying out the invention, or those unrelated to enabling the claimed invention). It should be appreciated that in the development of any such actual implementation, as in any engineering or design project, numerous implementation specific decisions may be made. Such a development effort might be complex and time consuming, but would nevertheless be a routine undertaking of design, fabrication, and manufacture for those of ordinary skill having the benefit of this disclosure, without undue experimentation.

1-20. (canceled)

21. A vehicle interior assembly comprising:
a base;
a light source;
a component movable relative to the base and configured so that movement of the component relative to the base comprises:
a first state with the component in a first position;
a second state with the component in a second position;
a third state with the component in a third position;
wherein when the component is in the first state a first light transmissive element is illuminated by the light source; and
wherein when the component is in the second state a second light transmissive element is illuminated by the light source.

22. The vehicle interior assembly of claim 21 wherein the base comprises a support structure and the component comprises a movable storage compartment;
wherein the support structure and the movable storage component form an interior trim component at least partially enclosing a storage volume and comprising a recessed compartment wherein the interior trim component is configured to transition between the first state, the second state, and the third state;
the first light transmissive element is coupled to the interior trim component and configured to provide illumination while the interior trim component is in the first state;
the second light transmissive element is coupled to the interior trim component and configured to provide illumination while the interior trim component is in the second state; and
wherein the light source is coupled to the support structure and positioned to optically communicate with the first light transmissive element while the interior trim component is in the first state, to optically communicate with the second light transmissive element while the interior trim component is in the second state, and to otherwise illuminate an interior of the storage volume.

23. The vehicle interior assembly of claim 22 wherein the movable storage compartment comprises a handle movable from a first handle position to a second handle position to facilitate movement of the component relative to the base;
wherein the first light transmissive element is configured to provide illumination through the first light transmissive element for the handle.

24. The vehicle interior assembly of claim 23 wherein the first position is a closed position, and the first light transmissive element is optically coupled to the light source by an interface configured to provide continuous illumination of the handle when the handle is actuated.

25. The vehicle interior assembly of claim 22 comprising a third light transmissive element coupled to an exterior surface of the interior trim component and optically coupled to the first light transmissive element.

26. The vehicle interior assembly of claim 25 wherein the third light transmissive element comprises a lens.

27. The vehicle interior assembly of claim 22 wherein the first light transmissive element comprises an interface comprising a first section and a second section movable relative to the first section;
wherein the interface further comprises a guide to facilitate movement of the second section relative to the first section.

28. The vehicle interior assembly of claim 27 wherein the interface comprises a first light guide and the second light transmissive element comprises a second light guide.

29. The vehicle interior assembly of claim 27 wherein the first section of the interface comprises a first light guide section, and the second section of the interface comprises a second light guide section movable relative to the first light guide section within the guide.

30. The vehicle interior assembly of claim 21 wherein the light source comprises a light emitting diode (LED).

31. A vehicle interior assembly comprising:
a base;
a light source configured to provide light;
a component movable relative to the base and configured so that movement of the component relative to the base comprises a first state with the component in a first position and a second state with the component in a second position; and
an interface comprising a first section and a second section movable relative to the first section within a guide;
wherein the first section and the second section are engaged when the component is in the first position, and the light from the light source is transmitted through the second section of the interface when the component is in the first position;
wherein the first section and the second section are separated when the component is in the second position, and the light from the light source is transmitted through the second section of the interface when the component is in the second position;
wherein the light from the light source is transmittable from the first section to the second section;
wherein the guide is configured to facilitate alignment of the first section with the second section and separation of the first section and the second section.

32. The vehicle interior assembly of claim 31 wherein the second section of the interface is movable within the guide of the interface.

33. The vehicle interior assembly of claim 31 comprising a handle configured to facilitate movement of the component relative to the base;
wherein illumination is provided for the handle from the light source through the interface.

34. The vehicle interior assembly of claim 33 wherein the handle is movable between a first handle position and a second handle position, and illumination is provided for the handle in the first handle position and in the second handle position;
wherein the second section of the interface is optically coupled to the light source to provide illumination for the handle.

35. The vehicle interior assembly of claim 34 wherein illumination is provided for the handle as it moves between the first handle position and the second handle position.

36. The vehicle interior assembly of claim 31 wherein the interface comprises a light transmissive element.

37. The vehicle interior assembly of claim 31 comprising a light transmissive element coupled to an exterior surface of the component and optically coupled to the light source through the interface.

38. The vehicle interior assembly of claim 31 wherein the light transmissive element comprises a lens.

39. The vehicle interior assembly of claim 31 wherein the light source comprises a light emitting diode (LED).

40. The vehicle interior assembly of claim 31 wherein the interface with the first section and the second section comprises a slidably coupled variable length light guide configured to transmit the light from the light source through the first section and the second section.

41. The vehicle interior assembly of claim 31 wherein the interface is configured so that the second section is movable relative to the first section within a functional range of motion, and the light is transmitted through the interface within the functional range of motion regardless of position of the second section relative to the first section.

42. A vehicle interior assembly comprising:
a base;
a handle;
a light source configured to provide light to illuminate a first light transmissive element and a second light transmissive element;
a component movable relative to the base and configured so that movement of the component relative to the base comprises:
a closed state with the component in a closed position;
a first open state to provide access to a first storage compartment; and
a second open state to provide access to a second storage compartment;
wherein when the component is in the first open state the first light transmissive element is illuminated to provide lighting for the first storage compartment;
wherein when the component is in the second open state the light source provides lighting for the second storage compartment;
wherein when the component is in the closed state the second light transmissive element is illuminated to provide lighting for the handle.

43. The vehicle interior assembly of claim 42 wherein the base provides the second storage compartment, and the component provides the first storage compartment.

44. The vehicle interior assembly of claim 42 comprising a third light transmissive element coupled to an exterior surface of the interior component and optically coupled to the second light transmissive element.

45. The vehicle interior assembly of claim 44 wherein the third light transmissive element comprises a lens.

46. The vehicle interior assembly of claim 42 wherein lighting is provided for the handle from the light source through an interface;
wherein the interface comprises a light guide.
